(19) United States
(12) Patent Application Publication
(10) Pub. No.: US 2023/0249984 A1
(43) Pub. Date: Aug. 10, 2023

(54) COMPRESSIBLE UNPRESSURIZED WATER TANK FOR WATER FILTRATION SYSTEMS

(71) Applicant: Zhuangyong Chen, Cumming, CA (US)

(72) Inventor: Zhuangyong Chen, Cumming, CA (US)

(21) Appl. No.: 18/107,273

(22) Filed: Feb. 8, 2023

Related U.S. Application Data
(60) Provisional application No. 63/307,644, filed on Feb. 8, 2022.

(51) Int. Cl. C02F 1/00

(52) U.S. Cl. CPC C02F 1/001; C02F 2201/005; C02F 2209/03; C02F 2307/06

(57) ABSTRACT

A compressible tank for supplying water under pressure, such as in water filtration systems. The compressible tank includes a pleated body that can compress and expand upon folding and unfolding of the pleats, respectively. The compressible tank includes a pump, a pressure sensor, and a float valve. The pump can supply the water under pressure. The pressure sensor can operate the pump based on the pressure at the outlet port. The float valve can open and close the inlet valve based on the level of the water in the body.

### CROSS-REFERENCE TO RELATED APPLICATIONS

This application claims priority from a U.S. Provisional Pat. App. Ser. No. 63/307,644, filed on Feb. 08, 2022, which is incorporated herein by reference in its entirety.

### FIELD OF INVENTION

The present invention relates to a compressible water tank for water filtration systems, and more particularly, the present invention relates to a compressible and unpressurized water tank for water filtration systems.

### BACKGROUND

Pressure tanks are used in water filtration systems to provide water under pressure. Pressure tanks are used in under-counter reverse osmosis systems for supplying water to the faucet. The pressure tanks include an air bladder and when water is pumped into the pressure tank, the air gets compressed, putting the water under pressure. The known pressure tanks suffer from one or more drawbacks. The primary drawback is that the pressure tanks cannot be repaired in case the bladder is breached. The known metal pressure tanks are heavy, cumbersome, and expensive. A need is therefore appreciated for a novel pressure water tank that is devoid of the drawbacks of known metal pressure tanks.

### SUMMARY OF THE INVENTION

The following presents a simplified summary of one or more embodiments of the present invention in order to provide a basic understanding of such embodiments. This summary is not an extensive overview of all contemplated embodiments and is intended to neither identify key or critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to a compressible tank that is light in weight and compact.

It is another object of the present invention that the compressible tank can be compressed and expanded.

It is still another object of the present invention that the compressible tank can be easily repaired.

It is yet another object of the present invention that the compressible tank is easy to install.

It is a further object of the present invention that the compressible tank is economical to manufacture.

It is still a further object of the present invention that the compressible tank is durable and has a long life.

It is yet a further object of the present invention that the compressible tank is safe for holding drinking water.

It is an additional object of the present invention that high and stable flow rates can be obtained.

It is still an additional object of the present invention that the compressible tank can be manufactured in large capacities up to one thousand liter.

In one aspect, disclosed is a compressible tank for supplying water under pressure, the compressible tank comprises a body, the body is composed of circumferential pleats that extend along a length thereof, the pleats upon folding causes the body to be compressed, and the pleats upon unfolding results in expansion of the body; a base, the base has an inlet port for receiving water into the body and an outlet port for supplying water under pressure from the body; a pump encased within the base, the pump configured for supplying the water under pressure from the body; and a pressure sensor operably coupled to the pump, the pressure sensor configured to detect an opening and closing of a faucet, the pressure sensor upon detecting the opening of the faucet sends an on signal to the pump and the pressure sensor upon detecting the closing of the faucet sends an off signal to the pump, the pump upon receiving the on signal turns on for supplying the water under pressure to the faucet and the pump upon receiving the off signal turns off. The compressible tank further comprises a float valve operably coupled to the inlet port, the float valve configured to open the inlet port for receiving water into the body and close the inlet port to stop receiving the water into the body, the float valve is configured to detect a level of water in the body and open and close the inlet port based on the level of water in the body. The body is cylindrical. The body is made from BPA-free plastic.

In one aspect, disclosed is a water filtration assembly comprising a water filtration system; and a compressible tank for supplying water under pressure, the compressible tank comprises a body, the body is composed of circumferential pleats that extend along a length thereof, the pleats upon folding compress the body, and the pleats upon unfolding causes the body to expand, a base, the base has an inlet port for receiving water into the body and an outlet port for supplying water under pressure from the body, the inlet port of the base connected to an output of the waterfiltration system, the outlet port is connected to a faucet, a pump encased within the base, the pump configured for supplying the water under pressure from the body, and a pressure sensor operably coupled to the pump, the pressure sensor configured to detect an opening and closing of the faucet, the pressure sensor upon detecting the opening of the faucet sends an on signal to the pump and the pressure sensor upon detecting the closing of the faucet sends an off signal to the pump, the pump upon receiving the on signal turns on for supplying the water under pressure to the faucet and the pump upon receiving the off signal turns off. The compressible tank further comprises a float valve operably coupled to the inlet port, the float valve configured to open the inlet port for receiving water into the body and close the inlet port to stop receiving the water into the body, the float valve is configured to detect a level of water in the body and open and close the inlet port based on the level of water in the body. The body is cylindrical or of any other shape. The body is made from BPA-free food-grade water-safe plastic.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a perspective view of a compressible tank, according to an exemplary embodiment of the present invention.

FIG. 2 is a front view of the compressible tank, according to an exemplary embodiment of the present invention.

FIG. 3 is another perspective view of the compressible tank, according to an exemplary embodiment of the present invention.

FIG. 4 shows a base of the compressible tank, according to an exemplary embodiment of the present invention.

FIG. 5 shows the body of the compressible tank, according to an exemplary embodiment of the present invention.

FIG. 6 is an exploded view of the compressible tank, according to an exemplary embodiment of the present invention.

FIG. 7 shows the compressible tank installed to a water purification system and a faucet, according to an exemplary embodiment of the present invention.

### DETAILED DESCRIPTION

Subject matter will now be described more fully hereinafter with reference to the accompanying drawings, which form a part hereof, and which show, by way of illustration, specific exemplary embodiments. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as methods, devices, components, or systems. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is to describe particular embodiments only and is not intended to be limiting of embodiments of the invention. As used herein, the singular forms “a”, “an” and “the” are intended to include the plural forms as well, unless the context clearly indicates otherwise. It will be further understood that the terms “comprise”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely to illustrate the general principles of the invention since the scope of the invention will be best defined by the allowed claims of any resulting patent.

Disclosed is a compressible tank for providing water under pressure. The disclosed compressible tank can be compressed and expanded for holding water. The disclosed compressible tank can be transported in a compressed form thus saving the cost of transportation. Moreover, the volume of the compressible tank can be adjusted according to the volume of water to be contained, thus the disclosed compressible tank is versatile and economical. The disclosed compressible tank can be particularly useful for an under-counter water purification system wherein the compressible tank can receive filtered water from the filtration system and supply the same under pressure to the faucet.

The disclosed compressible tanks can expand to receive more water; thus the user has the option to change capacity without replacing the water tank. When the water level in the tank increases, the tank expands accordingly to contain more water, while the water level decreases, it compresses itself.

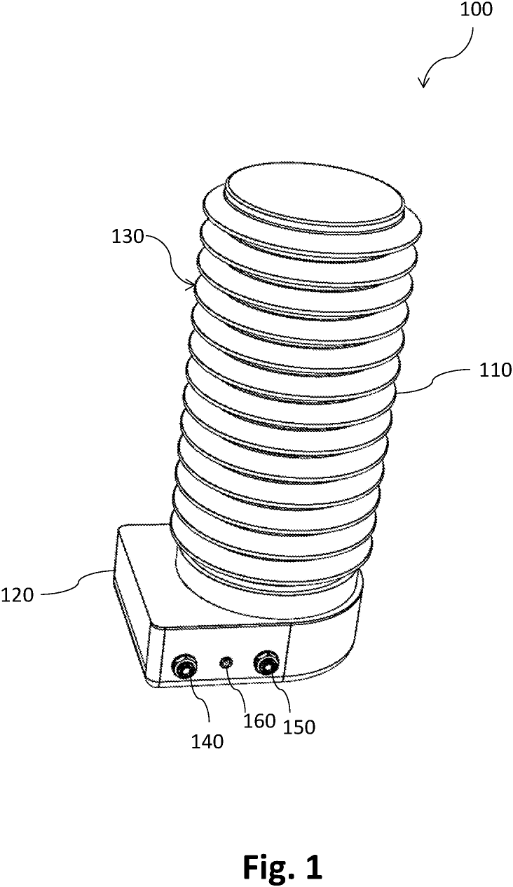

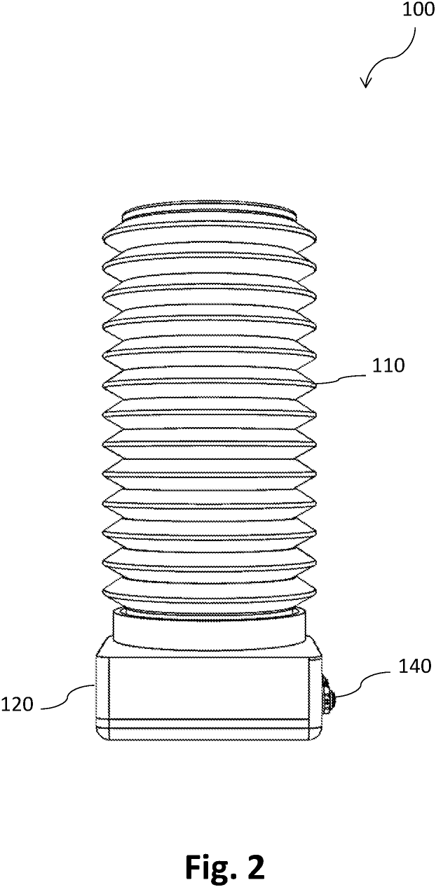

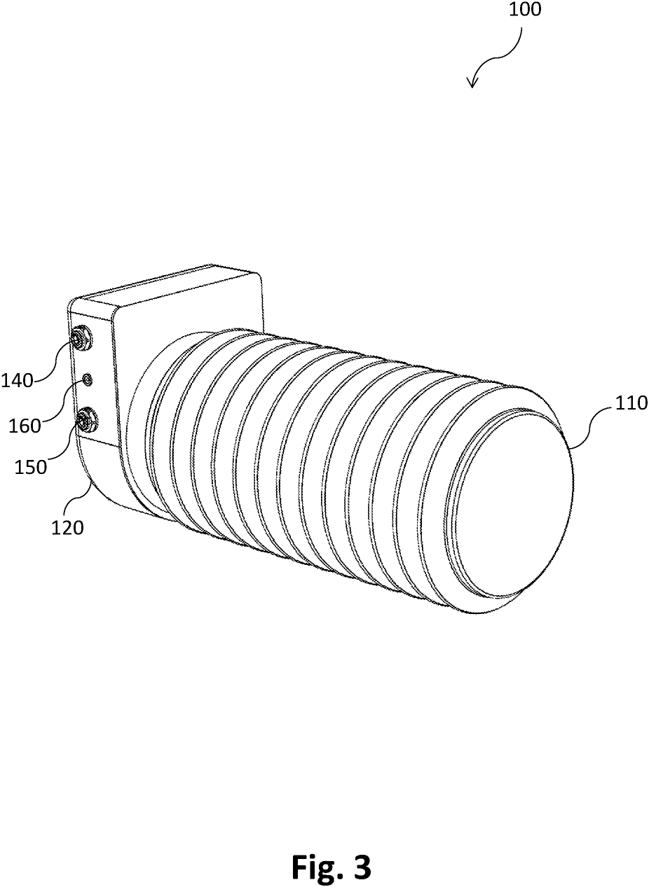

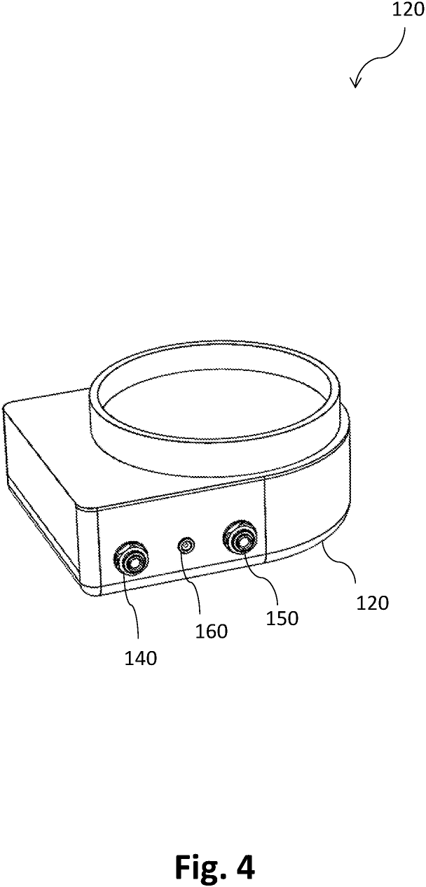

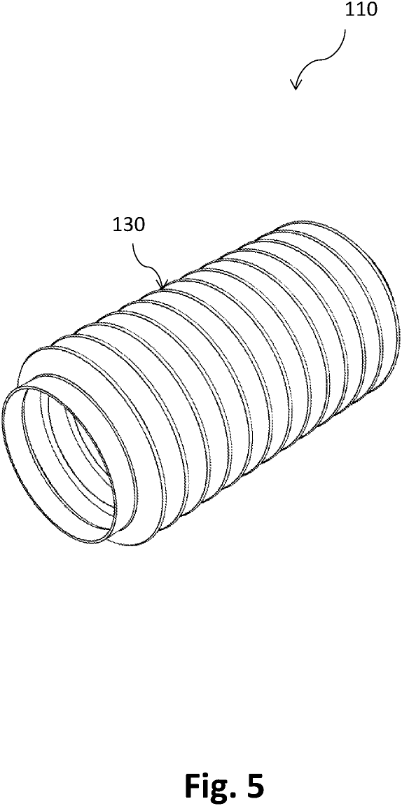

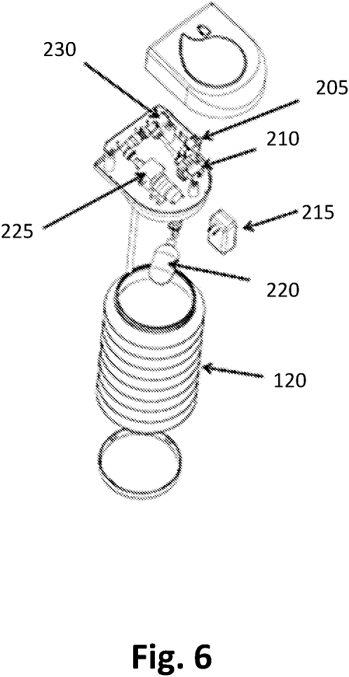

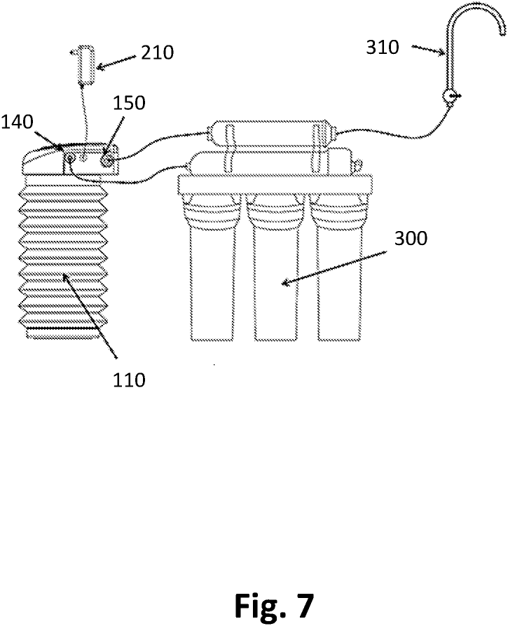

Referring to FIGS. 1-3 which show different views of the disclosed compressible tank, FIG. 4 shows the base of the compressible tank, FIG. 5 shows the body of the compressible tank, FIG. 6 shows an exploded view of the compressible tank, and FIG. 7 shows the compressible tank connected with a water purifying system. The compressible tank 100 can include a compressible body and a base 120. The compressible body can hold water and the base can encase the components. The compressible body has circumferential pleats 130 disposed along its length. The folding of these pleats allows the body to compress while the unfolding of these pleats allows the body to vertically expand. The number and size of these pleats define the maximum length of the body and thus maximum inner volume and the capacity to hold water. The body can preferably be cylindrical as shown in the drawings, however, any other shape such as elliptical, square, and the like is within the scope of the present invention. The compressible body can be made from plastic material, preferably plastic that is safe for storing drinking water, such as BPA-free plastic. Any other material suitable for making a pleated body is within the scope of the present invention. Also, the maximum length of the body i.e., when all the pleats are unfolded to their fullest extent, can be varied without departing from the scope of the present invention. FIG. 1 shows a pleated compressible body; however, pleats may be optional, and any plain flexible bag is within the scope of the present invention.

The body 110 can be mounted to the base 120. The base 120 is separately shown in FIG. 4. An exploded view of the disclosed compressible tank is shown in FIG. 6. The base 120 includes a water inlet 205, a pressure sensor 210, a power adaptor 215, a float switch 220, a built-in pump 225, and a water outlet 230. The water inlet 206 can be connected to the water inlet port and the water outlet 230 can be connected to a water outlet port 150. FIG. 4 also shows a power socket for connecting to a power supply.

FIG. 7 shows the disclosed compressible pump connected to a water filtration system. The water outlet of the filtration system can be connected to the water inlet port 140 and the water outlet port 150 can be connected to a faucet 310 for supplying stored filtered water. A power adaptor 210 is also shown in FIG. 7 which can be plugged into a power switch.

As the tank receives increasingly more purified water from a water filtration system 300 via the inlet port 140, it expands itself accordingly to contain more water. Once the water level reaches the tank’s maximum capacity and the tank is at its largest size, the float switch 220 automatically shuts off the water inlet port to stop receiving the water. After the water level drops from the tank’s maximum capacity, the float switch can open the water inlet port for receiving the water. A threshold or minimum water level can be set for the float valve so that the inlet port may open only when the water level in the tank drops to the threshold/minimum level. Also, the maximum capacity of the tank can be set by the user which may be below the actual maximum capacity. The float valve can be configured with a maximum capacity value that may be less than the actual maximum capacity of the tank.

The pressure sensor 210 can monitor the changes in the pressure caused by the opening of the faucet and immediately signifies the built-in pump 225. The pressure sensor can monitor the opening and closing of the faucet by sensing a change in pressure in the line connecting the faucet to the disclosed tank. In one implementation, the opening and closing of the faucet may result in pressure change which can be detected by the pressure sensor. Alternatively, the pressure sensor may apply some pressure in the water line, and this pressure may get disturbed upon opening of the faucet, and this disturbance can be sensed by the pressure sensor. Also, the closing of the faucet can restore the applied pressure which can be detected by the pressor sensor as a signal for closing the faucet. The pressure sensor can be in communication with the built-in pump for turning the built-in pump on and off depending upon the opening and closing of the faucet, respectively. The pressure sensor can send a signal to the built-in pump when the faucet is opened. The pressure sensor upon receiving the signal can turn on to pump the water to the faucet. Thus, water under pressure can flow through the faucet. Upon closing the faucet, the pressure sensor can send an off signal to the built-in pump, and the built-in pump turns off in response to the off signal. The signal by the pressure sensor and response from the built-in pump can be quick so that water can instantly flow upon opening the faucet and no pressure built up occurs upon closing the faucet.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A compressible tank for supplying water under pressure, the compressible tank comprises:
a body, the body is composed of circumferential pleats that extend along a length thereof, the pleats upon folding compress the body, and the pleats upon unfolding causes the body to expand;
a base, the base has an inlet port for receiving water into the body and an outlet port for supplying water under pressure from the body;
a pump encased within the base, the pump configured for supplying the water under pressure from the body; and
a pressure sensor operably coupled to the pump, the pressure sensor configured to detect an opening and closing of a faucet, the pressure sensor upon detecting the opening of the faucet sends an on signal to the pump and the pressure sensor upon detecting the closing of the faucet sends an off signal to the pump, the pump upon receiving the on signal turns on for supplying the water under pressure to the faucet and the pump upon receiving the off signal turns off.

2. The compressible tank according to claim 1, wherein the compressible tank further comprises:
a float valve operably coupled to the inlet port, the float valve configured to open the inlet port for receiving water into the body and close the inlet port to stop receiving the water into the body, the float valve is configured to detect a level of water in the body and open and close the inlet port based on the level of water in the body.

3. The compressible tank according to claim 1, wherein the body is cylindrical.

4. The compressible tank according to claim 1, wherein the body is made from BPA-free plastic.

5. A water filtration assembly comprising:
a water filtration system; and
a compressible tank for supplying water under pressure, the compressible tank comprises:
a body, the body is composed of circumferential pleats that extend along a length thereof, the pleats upon folding compress the body, and the pleats upon unfolding causes the body to expand,
a base, the base has an inlet port for receiving water into the body and an outlet port for supplying water under pressure from the body, the inlet port of the base connected to an output of the water filtration system, the outlet port is connected to a faucet,
a pump encased within the base, the pump configured for supplying the water under pressure from the body, and
a pressure sensor operably coupled to the pump, the pressure sensor configured to detect an opening and closing of the faucet, the pressure sensor upon detecting the opening of the faucet sends an on signal to the pump and the pressure sensor upon detecting the closing of the faucet sends an off signal to the pump, the pump upon receiving the on signal turns on for supplying the water under pressure to the faucet and the pump upon receiving the off signal turns off.

6. The water filtration assembly according to claim 5, wherein the compressible tank further comprises:
a float valve operably coupled to the inlet port, the float valve configured to open the inlet port for receiving water into the body and close the inlet port to stop receiving the water into the body, the float valve is configured to detect a level of water in the body and open and close the inlet port based on the level of water in the body.

7. The water filtration assembly according to claim 5, wherein the body is cylindrical.

8. The water filtration assembly according to claim 5, wherein the body is made from BPA-free plastic.
